(19) United States
(12) Patent Application Publication
(10) Pub. No.: US 2026/0070472 A1
(43) Pub. Date: Mar. 12, 2026

(54) LONG SLIDE RAIL SYSTEM FOR VEHICLE SEAT

(71) Applicant: HYUNDAI TRANSYS INC., Seosan-si (KR)

(72) Inventors: Cheon KIM, Hwaseong-si (KR); Jae Yong JANG, Suwon-si (KR); Kyeong Ho SEO, Suwon-si (KR); Heoung Su LIM, Hwaseong-si (KR); Jung Hyun HAN, Hwaseong-si (KR); Seong Jun HWANG, Hwaseong-si (KR)

(21) Appl. No.: 19/308,883

(22) Filed: Aug. 25, 2025

(30) Foreign Application Priority Data
Sep. 11, 2024 (KR) 10-2024-0123788

(51) Int. Cl. B60N 2/06; B60N 2/02; B60N 2/12

(52) U.S. Cl. CPC B60N 2/06; B60N 2/02253; B60N 2/0228; B60N 2/12

(57) ABSTRACT

A long slide rail system for a vehicle seat, includes a lower rail extending lengthwise along a floor panel of a vehicle, the lower rail being fixedly installed on the floor panel, an upper rail coupled to the lower rail and mounted on a seat cushion, the upper rail being configured to enable the seat cushion to be slidably movable along the lower rail, a first gear module fixedly mounted on the upper rail and connected to a drive motor, a second gear module coupled in an axially rotatable manner to the first gear module, the second gear module including a pinion gear engaged with a rack gear provided on the lower rail, and a guide module configured to selectively rotate the second gear module to disengage the pinion gear from the rack gear such that the second gear module is switched from an electric mode to a manual mode.

### CROSS-REFERENCE TO RELATED APPLICATION

This application claims, under 35 U.S.C. § 119 (a), the benefit of priority from Korean Patent Application No. 10-2024-0123788, filed on Sep. 11, 2024, the entire contents of which are incorporated herein by reference.

### BACKGROUND

### (a) Technical Field

The present disclosure relates to a long slide rail system for a vehicle seat, and more particularly, to a long slide rail system for a vehicle seat capable of securing quality and reducing costs through structural improvement.

### (b) Background Art

In general, a vehicle seat includes a seatback and a seat cushion and is mounted on a seat sliding device configured to allow the seat cushion to be slidably moved in the forward-and-rearward direction of a vehicle body.

Normally, a front seat is mounted on a sliding device formed to have a short longitudinal length and configured to provide a short forward-and-rearward movement distance. Conversely, in the case of recreational vehicles (RVs) and vans having a larger vehicle body and a larger floor panel than those of passenger cars, a sliding device formed to have a long longitudinal length is installed therein to increase a degree of adjustment for a forward-and-rearward movement distance of a vehicle seat. Accordingly, sufficient leg room for a passenger may be secured, and a comfortable interior living space may be provided.

The above-described seat sliding devices may be classified into a manually-operated seat sliding device and an electrically-operated seat sliding device depending on the operation method thereof, and the electrically-operated seat sliding device is widely used to increase user convenience.

Here, in a structural configuration of the electrically-operated seat sliding device, an upper rail fixedly installed on a vehicle seat is movable along a lower rail fixedly installed on the vehicle floor by a drive motor, a gear box (a reducer), and a lead screw, enabling the vehicle seat to be movable forwards and rearwards.

Meanwhile, vehicle electrification has advanced dramatically in consideration of recent demand for improvement in user convenience, and various convenience specifications for a driver seat and a passenger seat have significantly increased to improve ride comfort and driving convenience.

Particularly, highly complex techniques are applied to the driver seat and the passenger seat so as to provide various conveniences to a user. Examples of the highly complex techniques include a sliding function of allowing a seat to be slidably moved forwards and rearwards, a seat height adjustment function of allowing a user to secure a view in front of a vehicle, a ventilation and heater supply function for comfortable driving, a reclining function of adjusting the angle of a seatback, and various convenience facilities such as a heating/cooling control switch and a monitor installed on the back surface of a seatback for a passenger sitting on a rear seat.

Among the above-mentioned techniques, in order to implement sliding movement of a seat in the forward-and-rearward direction, the sliding function may be performed by transmitting power and movement direction signals to vehicle electronics. In this case, as described above, various problems may occur because the sliding device is installed in the form of a long sliding device.

For example, in the case of a vehicle equipped with a long sliding device, when a passenger sitting on the third-row seat enters or exits the vehicle, the second-row seat needs to be first moved forwards, and then the passenger enters or exits the vehicle. Here, in the case of an electric seat, since the electric seat is not moved forwards or rearwards as fast as the passenger desires, the passenger may be dissatisfied with the forward or rearward movement of the electric seat.

In order to address the above-described problems, there is provided a long slide rail system configured to be driven in an electric mode during normal times and to be selectively driven in a manual mode when a passenger sitting on the third-row seat enters or exits the vehicle.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a long slide rail system for a vehicle seat, configured to switch an operation mode from an electric mode to a manual mode in such a manner that a seatback is first rotated in the folding direction through operation of a lever, a cable is accordingly pulled by rotation of the seatback such that a rotating housing cover connected to the cable is rotated relative to a fixed housing cover, and a pinion gear is selectively disengaged from a rack gear. Through such a structural configuration, the long slide rail system enables a seat having a mechanical connection structure to easily switch from the electric mode to the manual mode.

In one aspect, the present disclosure provides a long slide rail system for a vehicle seat, the long slide rail system including a lower rail configured to extend lengthwise along a floor panel of a vehicle, the lower rail being fixedly installed on the floor panel, an upper rail coupled to the lower rail and mounted on a seat cushion, the upper rail being configured to enable the seat cushion to be slidably movable along the lower rail, a first gear module fixedly mounted on the upper rail, the first gear module being connected to a drive motor, a second gear module coupled in an axially rotatable manner to the first gear module, the second gear module including a pinion gear engaged with a rack gear provided on the lower rail, and a guide module configured to selectively rotate the second gear module to disengage the pinion gear from the rack gear such that the second gear module is guided and moved by the guide module from a first position corresponding to an electric mode to a second position corresponding to a manual mode.

In a preferred embodiment, the second gear module may include a main body formed so that the pinion gear is to be mounted on an outer side thereof, the main body housing a plurality of gears to be mounted on an inner side thereof, each of the gears being configured to transmit driving force of the first gear module to the pinion gear, and a connecting member coupled to the main body, the connecting member configured to vertically extend from the main body so as to be connected to the guide module.

In another preferred embodiment, an upper part of the main body may be arranged to extend obliquely so as to be coupled to a rear side of the first gear module.

In still another preferred embodiment, the second gear module may further include an elastic member connected to the first gear module, and the elastic member may be configured to provide elastic force to the second gear module at an initial position, and to provide elastic restoring force clockwise to the second gear module upon the connecting member being moved upwards such that the main body is rotated relative to the first gear module counterclockwise from the initial position.

In yet another preferred embodiment, the guide module may include a first driving guide formed to be rotated in conjunction with rotation of a seatback rotatably coupled to the seat cushion, a second driving guide selectively located to be caught by the first driving guide through rotation of the first driving guide, the second driving guide being formed to be rotated in a direction opposite to a rotation direction of the first driving guide, and a third driving guide formed to selectively move the connecting member upwards upon being rotated by a first cable, the first cable being movable in a direction in which the first cable is pulled by rotation of the second driving guide.

In still yet another preferred embodiment, the third driving guide may include a first bracket connected to the first cable, the first bracket configured to be selectively rotated upon being moved in the direction in which the first cable is pulled, and a second bracket formed to extend from the first bracket, the second bracket being rotated in conjunction with rotation of the first bracket to selectively move a locking module to an unlocked position.

In a further preferred embodiment, the locking module may be mounted on the upper rail and may be formed to be selectively unlocked from a locking hole provided in the lower rail upon being pressed by the second bracket.

In another further preferred embodiment, the guide module may further include an operating lever connected to the first driving guide through a second cable, the operating lever being formed to rotate the seatback by moving the second cable in a direction in which the second cable is pulled.

In still another further preferred embodiment, the guide module may include a switching guide connected to a seatback rotatably coupled to the seat cushion, the switching guide being configured to transmit driving force to switch the seatback from the first position corresponding to the electric mode to the second position corresponding to the manual mode.

In yet another further preferred embodiment, the switching guide may include a support member rotatably coupled by a restoring spring to the seatback, a first rotation member configured to be rotatable, the first rotation member including a locking piece configured to be inserted into the support member and a locking groove formed at a location opposite from the locking piece, a second rotation member positioned so as to be caught by the first rotation member during rotation, wherein the second rotation member is selectively inserted into the locking groove to guide and rotate the first rotation member such that the first rotation member is unlocked from the support member, and a third rotation member coupled to the second rotation member and configured to be rotated in conjunction with rotation of the second rotation member, the third rotation member being connected to an operating lever by an operating cable.

In still yet another further preferred embodiment, the operating lever may be mounted on at least one of the seat cushion and the seatback and may be configured to rotate the third rotation member by moving the operating cable in a direction in which the operating cable is pulled.

In a still further preferred embodiment, the first position may be set to allow the first rotation member to be locked in the support member, and the second position may be set to allow the first rotation member to be unlocked from the support member.

In a yet still further preferred embodiment, the guide module may further include a locking module mounted on the upper rail, the locking module being inserted into a locking hole provided in the lower rail to restrict sliding movement of the upper rail, and the locking module may be unlocked from the locking hole by driving an actuator.

In another preferred embodiment, the locking module may be rotated by operation of a locking guide connected to the actuator, and the locking module may be unlocked from the locking hole to enable, by driving a slide motor, the sliding movement of the upper rail.

In still another preferred embodiment, the switching guide may be selectively operated by operation of the operating lever.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are views each showing switching from an electric mode to a manual mode in a long slide rail system for a vehicle seat according to an embodiment of the present disclosure;

FIGS. 3 and 4 are views each showing rotation of a seatback in the long slide rail system for a vehicle seat according to the embodiment of the present disclosure;

FIGS. 5 and 6 are views each showing operation of an operating lever in the long slide rail system for a vehicle seat according to the embodiment of the present disclosure;

FIGS. 7 and 8 are views each showing operation of a first driving guide and a second driving guide in the long slide rail system for a vehicle seat according to the embodiment of the present disclosure;

FIGS. 9 to 11 are views each showing operation of a third driving guide in the long slide rail system for a vehicle seat according to the embodiment of the present disclosure;

FIGS. 12A and 12B are views each showing operation of a second gear module in the electric mode of the long slide rail system for a vehicle seat according to the embodiment of the present disclosure;

FIGS. 13A and 13B are views each showing the operation of the second gear module in the manual mode of the long slide rail system for a vehicle seat according to the embodiment of the present disclosure;

FIGS. 14A to 14D are views each showing the operation of the second gear module in the long slide rail system for a vehicle seat according to the embodiment of the present disclosure;

FIG. 15 is a view showing a switching guide in the long slide rail system for a vehicle seat according to the embodiment of the present disclosure; and

FIGS. 16 to 19 are views each showing operation of the switching guide in the long slide rail system for a vehicle seat according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, a preferred embodiment according to the present disclosure will be described in detail with reference to the accompanying drawings.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to make the present disclosure complete, and to fully inform those skilled in the art to which the present disclosure pertains of the scope of the disclosure, and the present disclosure is only defined by the scope of the claims.

In describing the embodiments disclosed herein, when it is determined that a detailed description of publicly known techniques to which the disclosure pertains may obscure the gist of the present disclosure, detailed description thereof will be omitted.

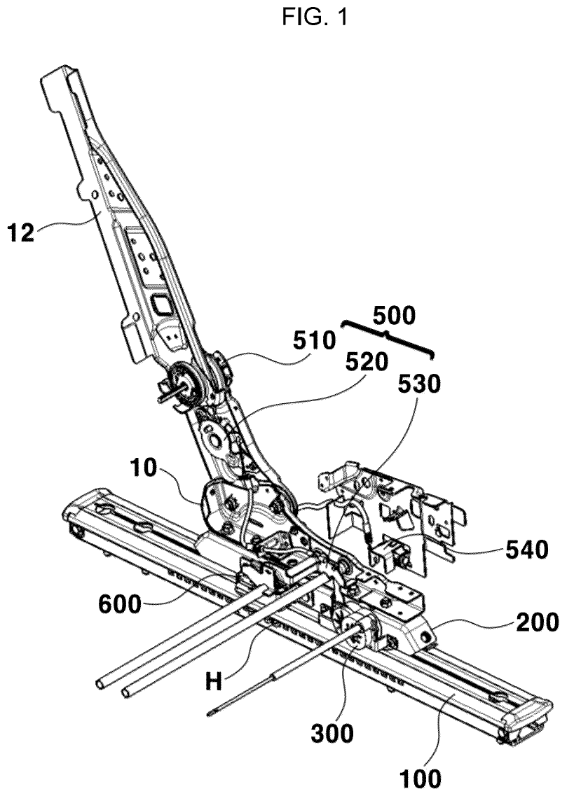

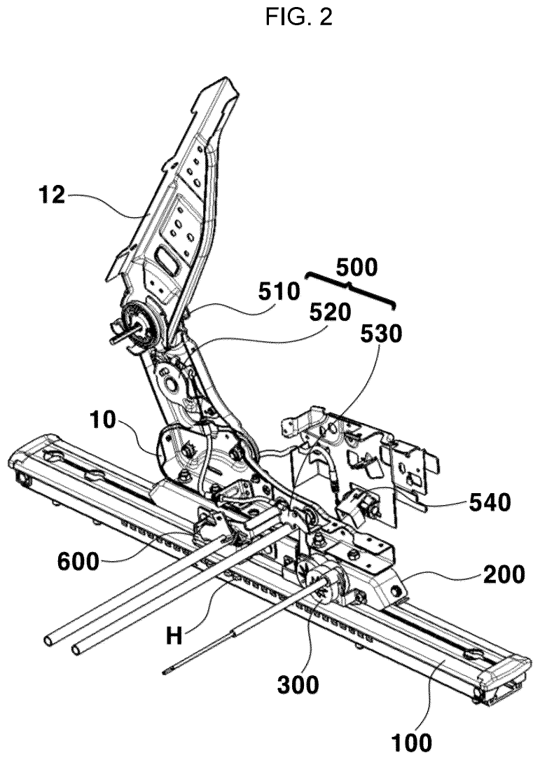

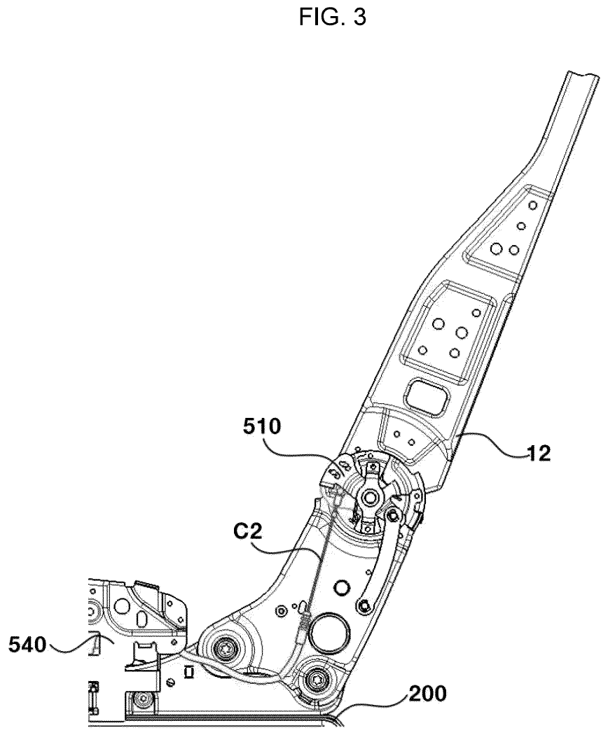

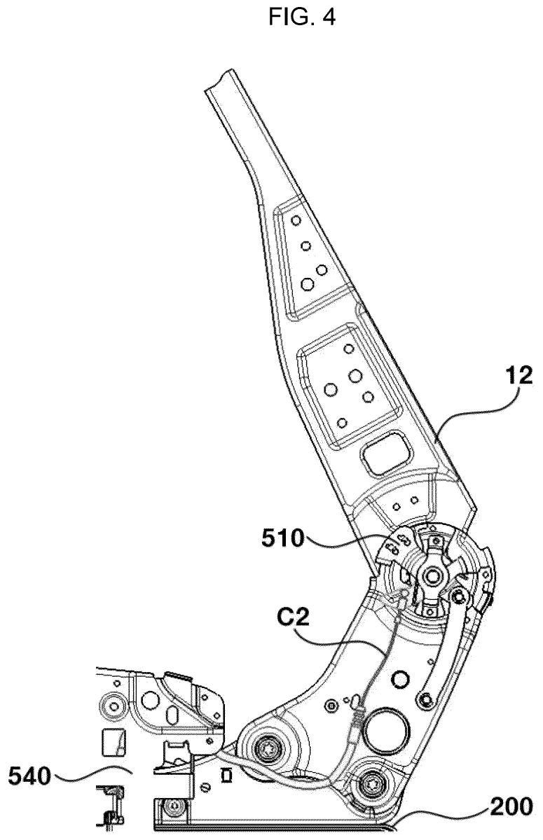

FIGS. 1 and 2 are views each showing switching from an electric mode to a manual mode in a long slide rail system for a vehicle seat according to an embodiment of the present disclosure, and FIGS. 3 and 4 are views each showing rotation of a seatback in the long slide rail system for a vehicle seat according to the embodiment of the present disclosure.

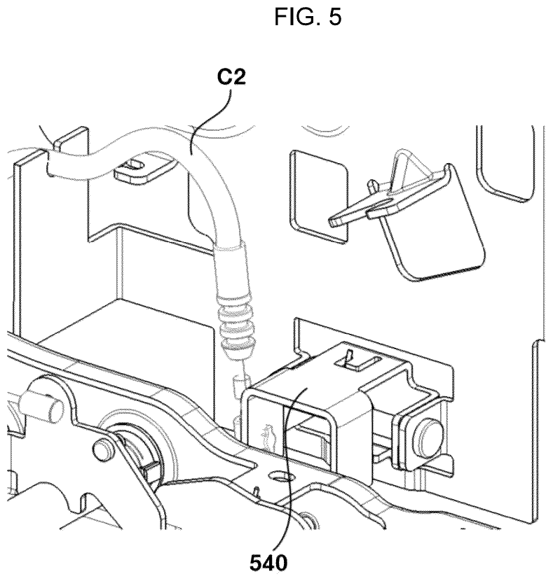

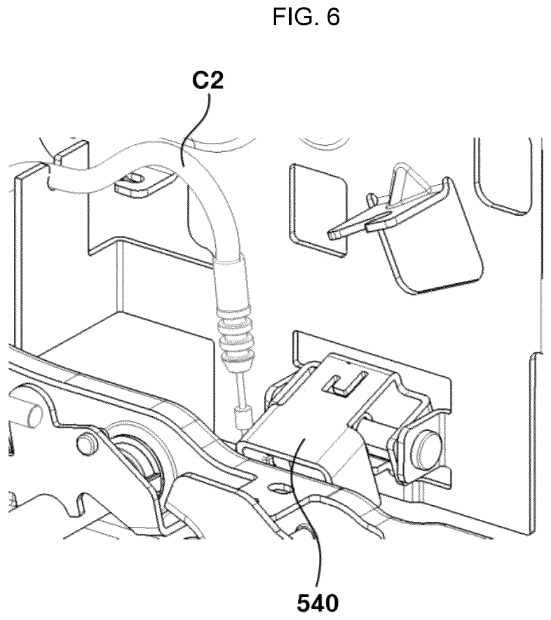

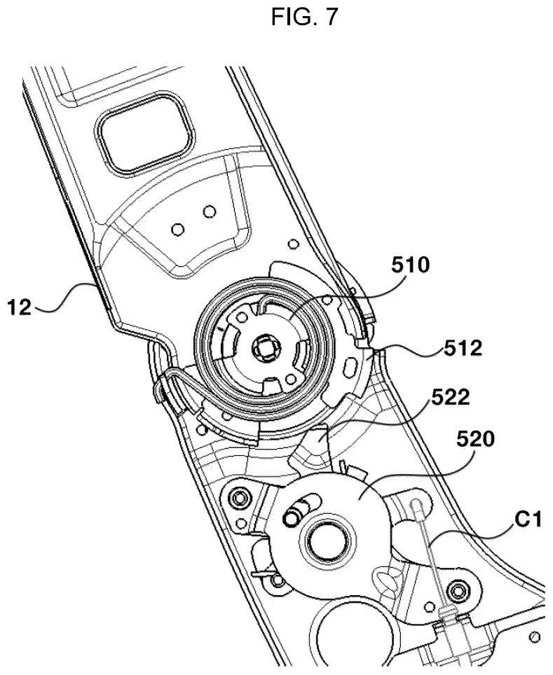

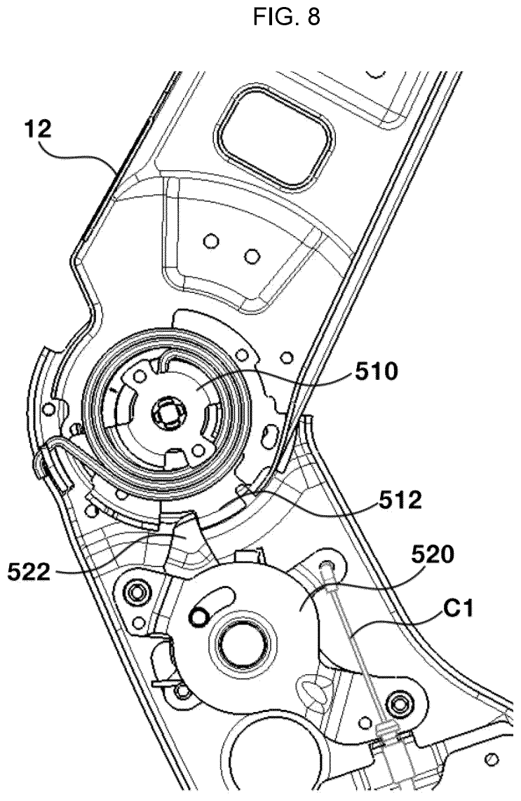

FIGS. 5 and 6 are views each showing operation of an operating lever in the long slide rail system for a vehicle seat according to the embodiment of the present disclosure, and FIGS. 7 and 8 are views each showing operation of a first driving guide and a second driving guide in the long slide rail system for a vehicle seat according to the embodiment of the present disclosure.

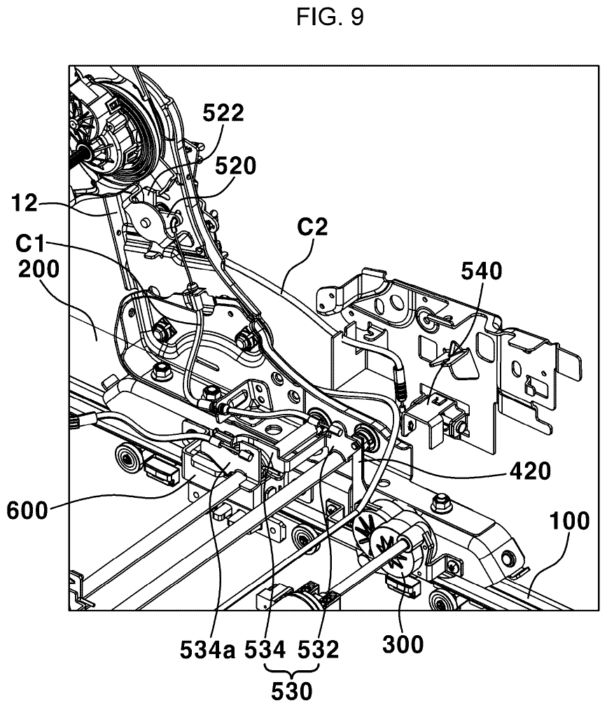

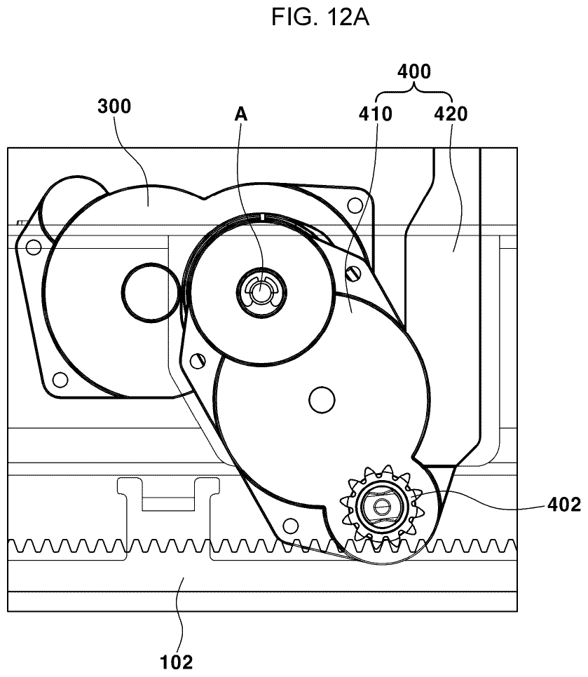

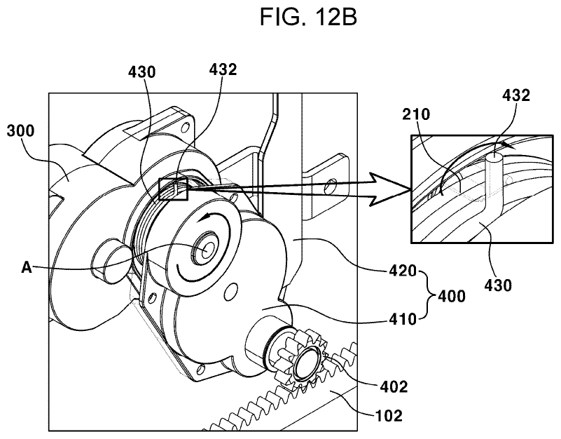

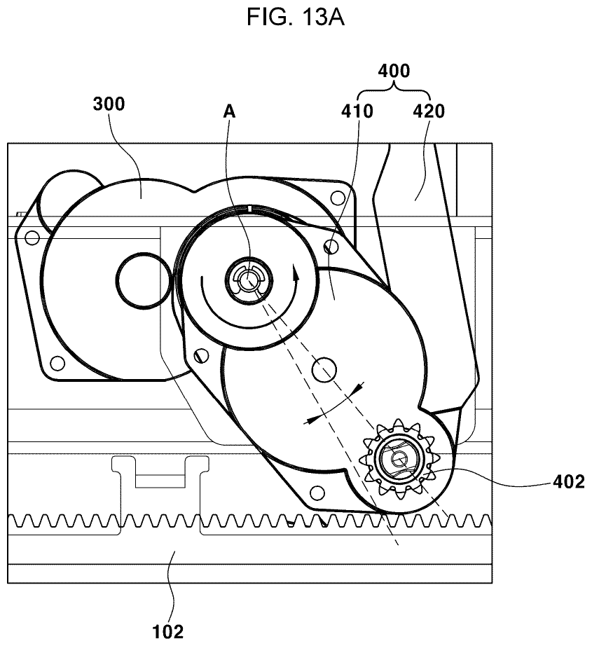

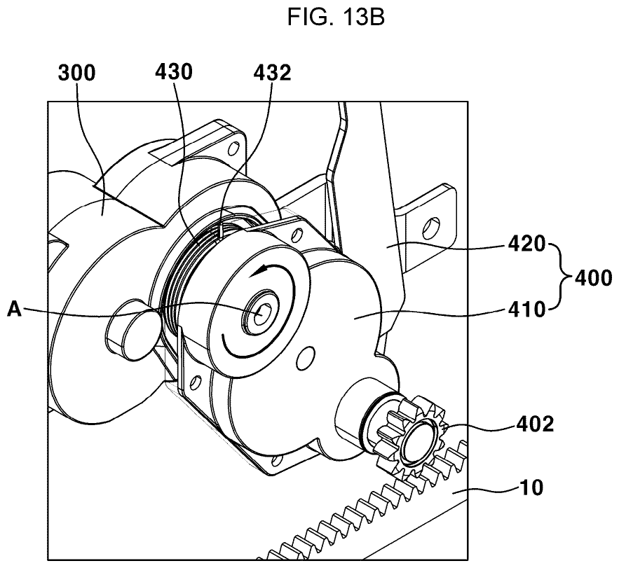

FIGS. 9 to 11 are views each showing operation of a third driving guide in the long slide rail system for a vehicle seat according to the embodiment of the present disclosure, FIGS. 12A and 12B are views each showing operation of a second gear module in the electric mode of the long slide rail system for a vehicle seat according to the embodiment of the present disclosure, and FIGS. 13A and 13B are views each showing the operation of the second gear module in the manual mode of the long slide rail system for a vehicle seat according to the embodiment of the present disclosure.

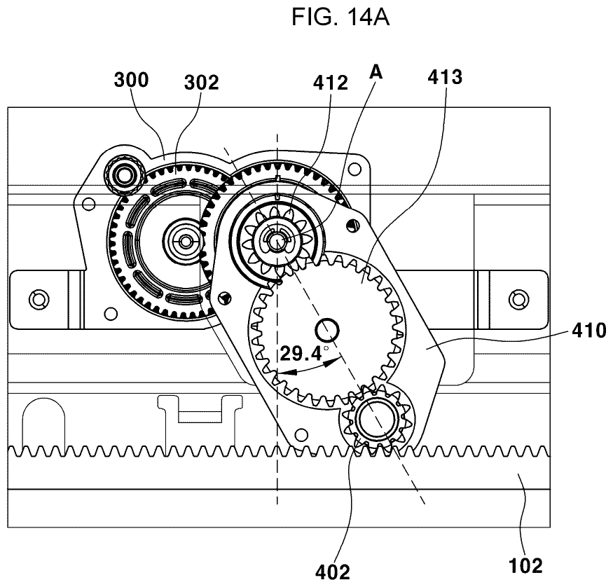

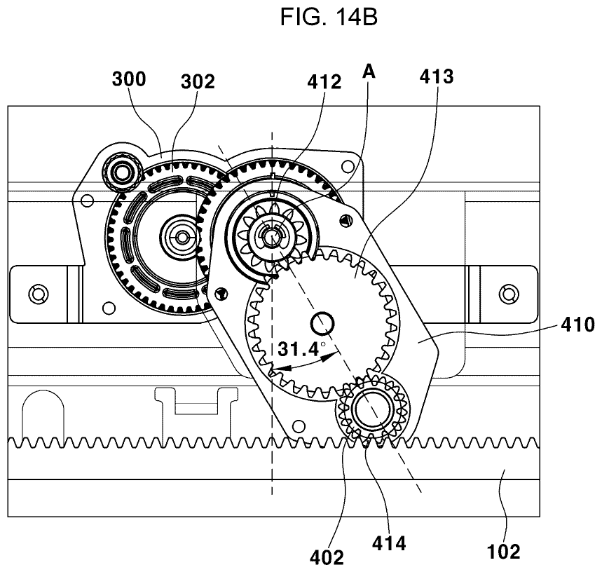

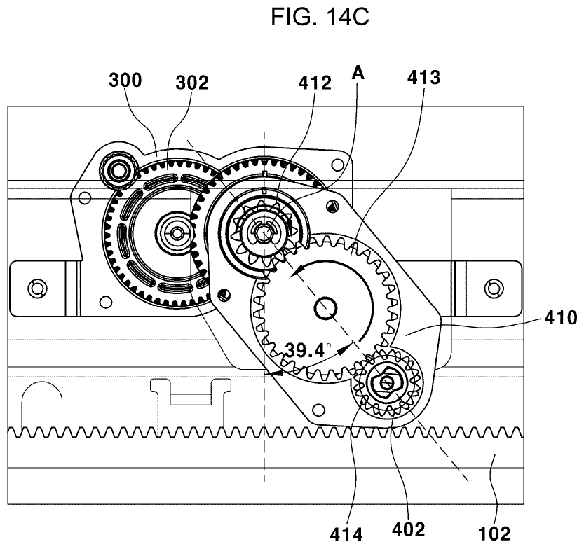

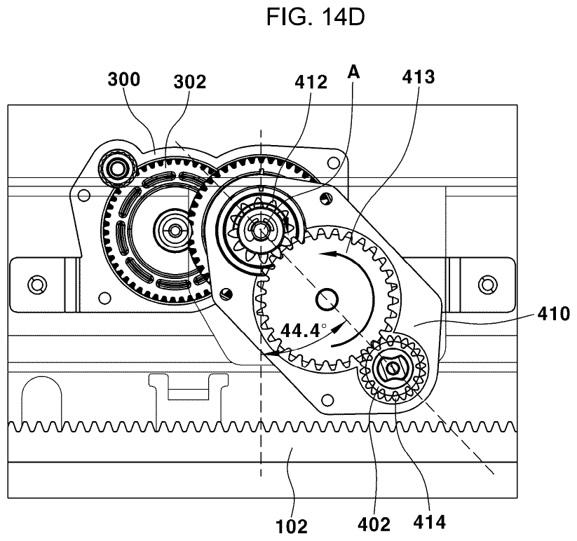

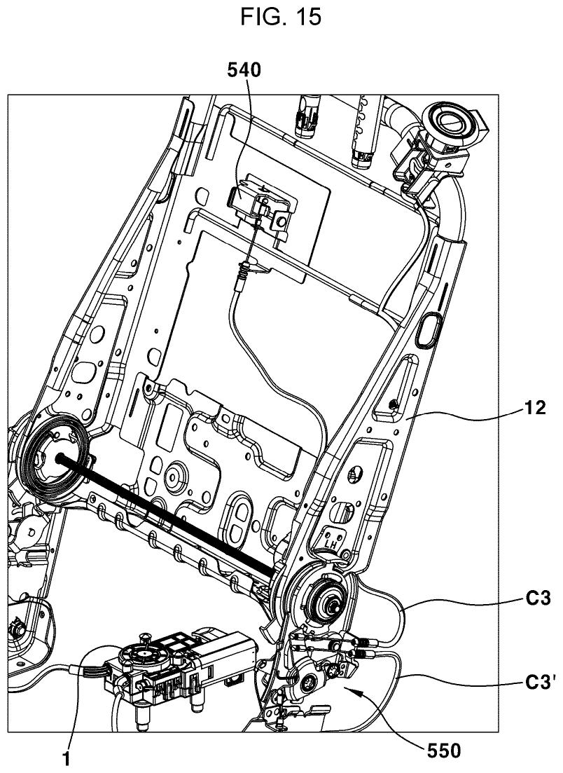

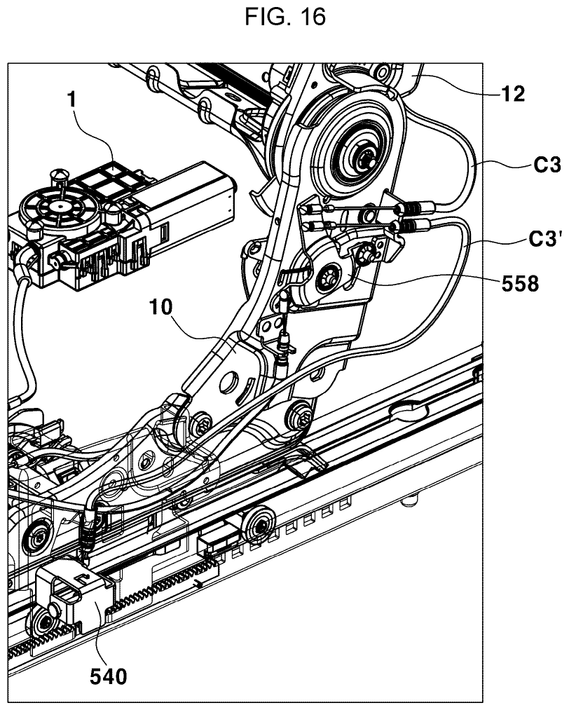

FIGS. 14A to 14D are views each showing the operation of the second gear module in the long slide rail system for a vehicle seat according to the embodiment of the present disclosure, FIG. 15 is a view showing a switching guide in the long slide rail system for a vehicle seat according to the embodiment of the present disclosure, and FIGS. 16 to 19 are views each showing operation of the switching guide in the long slide rail system for a vehicle seat according to the embodiment of the present disclosure.

As shown in FIG. 1, the long slide rail system for a vehicle seat according to the present embodiment includes a lower rail 100 and an upper rail 200.

The lower rail 100 extends lengthwise along a floor panel of a vehicle and is fixedly installed thereon, and as shown in FIGS. 12B and 13B, a rack gear 102 is provided inside the lower rail 100.

In addition, the upper rail 200 is coupled to the lower rail 100 and is mounted on a seat cushion 10. Further, the upper rail 200 is provided to enable the seat cushion 10 to be slidably moved along the lower rail 100.

In other words, the long slide rail system for a vehicle seat according to the present embodiment includes a gear module 300. In detail, when a gear 302 disposed inside the gear module 300 and connected to a drive motor (not shown) is rotated in the forward and reverse directions (refer to FIGS. 14A to 14D), the upper rail 200 may be moved in the forward-and-rearward direction of the lower rail 100.

Here, the upper rail 200 may be moved according to an electric mode or a manual mode, and the lower rail 100 having a long slide rail is mounted on the floor panel. For example, when a passenger sitting on the third-row seat enters or exits the vehicle, the second-row seat needs to be moved forwards. In this case, the upper rail 200 may be moved in the forward-and-rearward direction of the lower rail 100 in a state of selectively switching from the electric mode to the manual mode, thereby enabling the passenger sitting on the third-row seat to quickly enter or exit the vehicle.

To this end, the long slide rail system for a vehicle seat according to the present embodiment may include a second gear module 400 and a guide module 500.

As shown in FIGS. 12A and 13A, the second gear module 400 is coupled in an axially rotatable manner to the first gear module 300 and includes a pinion gear 402 engaged with the rack gear 102 provided on the lower rail 100.

The second gear module 400 may be axially rotated around a reference axis A of the first gear module 300 in a state in which the pinion gear 402 is engaged with the rack gear 102 (refer to FIG. 12B). Then, the pinion gear 402 may be disengaged from the rack gear 102 (refer to FIG. 13B), and the operation mode may switch from the electric mode to the manual mode.

Here, the second gear module 400 includes a main body 410 and a connecting member 420.

In detail, the pinion gear 402 is mounted on the outer side of the main body 410, and a plurality of gears (412 to 414) configured to transmit driving force of the first gear module 300 to the pinion gear 402 is mounted on the inner side of the main body 410.

That is, when the gear 302 disposed inside the first gear module 300, connected to the drive motor (not shown), is rotated in the forward and reverse directions, the gears (412 to 414) mounted inside the main body 410 are rotated in the corresponding directions, and the pinion gear 402 connected to the gear 414 is rotated, thereby enabling the upper rail 200 to be moved along the rack gear 102.

Through such a structural configuration, as shown in FIG. 14A, since the pinion gear 402 is engaged with the rack gear 102, the main body 410 causes the upper rail 200 to be moved along the rack gear 102 in the electric mode. When the operation mode switches from the electric mode to the manual mode, as shown in FIG. 14B to FIG. 14D, the connecting member 420 is gradually moved upwards, and the main body 410 is continuously rotated, for example, 31.4 degrees, 39.4 degrees, and 44.4 degrees. Accordingly, the pinion gear 402 is disengaged from the rack gear 102.

Preferably, an upper part of the main body 410 is obliquely coupled to the rear side of the first gear module 300 with an inclination of, for example, about 29.4 degrees relative to an imaginary line extending vertically from the reference axis A. In this manner, in a case where the main body 410 is rotated relative to the first gear module 300 by upward movement of the connecting member 420, even if the main body 410 is rotated by a minimum angle, for example, 10 degrees (refer to FIG. 14C), the pinion gear 402 may be easily disengaged from the rack gear 102.

In addition, the connecting member 420 is coupled to the main body 410 and is formed to extend from the main body 410 in the vertical direction. Then, the connecting member 420 is connected to the guide module 500 and is configured to be selectively moved upwards or downwards.

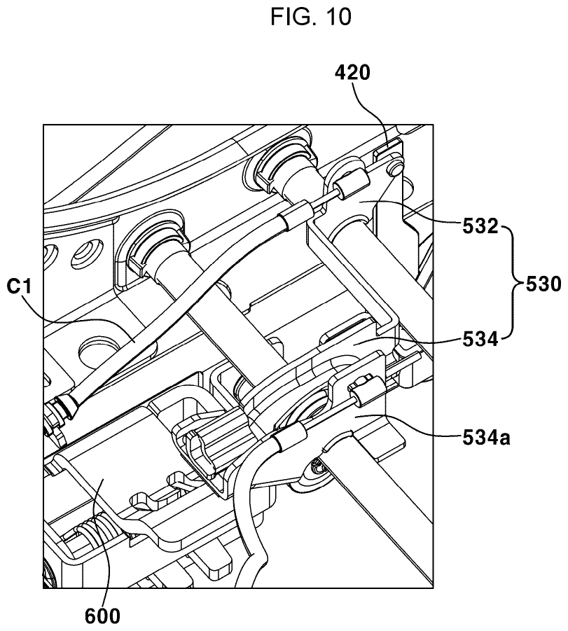

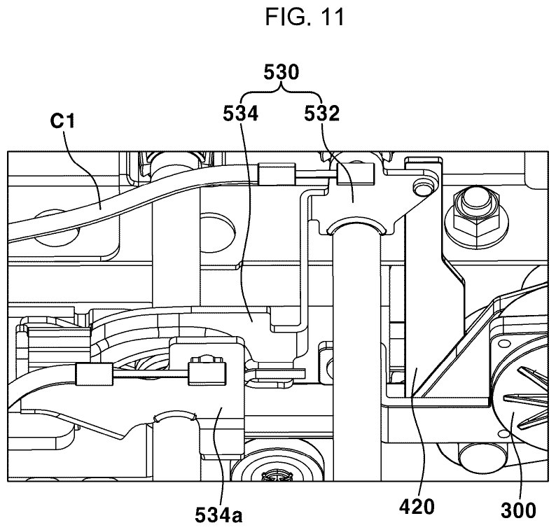

In other words, as shown in FIGS. 10 and 11, the connecting member 420 is connected to a first bracket 532 of a third driving guide 530, and when a first cable C1 is selectively pulled to switch the operation mode from the electric mode to the manual mode, the connecting member 420 is configured to be moved upwards.

In addition, as shown in FIGS. 12B and 13B the second gear module 400 may further include an elastic member 430 to be connected to the first gear module 300.

When a protruding extension protrusion 432 is located to be caught in a locking groove 210 provided in the upper rail 200 and the second gear module 400 is rotated, the elastic member 430 may provide elastic force to the second gear module 400.

In other words, the elastic member 430 provides elastic force to the second gear module 400 at the initial position, and when the connecting member 420 is moved upwards such that the main body 410 is rotated relative to the first gear module 300 counterclockwise from the initial position, the elastic member 430 is configured to provide elastic restoring force to the second gear module clockwise.

Therefore, since the elastic member 430 provides elastic restoring force to the second gear module 400 as described above, the second gear module 400 may quickly return to the initial position when the operation mode switches from the manual mode to the electric mode.

Meanwhile, the guide module 500 transmits driving force to the second gear module 400 so as to enable the second gear module 400 to switch from the first position corresponding to the electric mode to the second position corresponding to the manual mode.

That is, the guide module 500 transmits driving force to move the connecting member 420 upwards for rotation of the main body 410 and includes a first driving guide 510, a second driving guide 520, and the third driving guide 530.

As shown in FIGS. 7 and 8, the first driving guide 510 is formed to be axially rotated in conjunction with rotation of a seatback 12 coupled to the seat cushion 10, and a locking member 512 is formed to protrude along the outer circumferential surface of the first driving guide 510.

The second driving guide 520 includes a protruding piece 522 formed along the outer circumferential surface thereof. Through such a structural configuration, when the first driving guide 510 is rotated, the protruding piece 522 is selectively caught by the rotating locking member 512 and is formed to be rotated in the opposite direction to the first driving guide 510.

As shown in FIGS. 9 to 11, the third driving guide 530 is formed to be rotated by the first cable C1 that is moved in a direction in which the first cable C1 is pulled by rotation of the second driving guide 520 such that the connecting member 420 is selectively moved upwards or downwards.

To this end, the third driving guide 530 includes a first bracket 532 and a second bracket 534.

The first bracket 532 is connected to the first cable C1 and is formed to be selectively rotated in a direction in which the first cable C1 is pulled (refer to FIGS. 10 and 11).

As shown in FIGS. 10 and 11, the second bracket 534 is formed to extend from the first bracket 532 and is integrated therewith. Accordingly, the second bracket 534 is rotated in conjunction with rotation of the first bracket 532 to press a locking module 600 through a transmission member 534a and to selectively move the locking module 600 to an unlocked position.

The locking module 600 is mounted on the upper rail 200 and is provided to restrict forward-and-rearward movement of the upper rail 200. When pressed by the second bracket 534, the locking module 600 is rotated and is selectively released from a locking hole H provided in the lower rail 100. Accordingly, as described above, when the connecting member 420 is moved upwards to switch the operation mode from the electric mode to the manual mode, the upper rail 200 is also switched to a manually movable state.

Meanwhile, the guide module 500 further includes an operating lever 540 connected to the first driving guide 510 through a second cable C2 and formed to rotate the seatback 12 by moving the second cable C2 in a direction in which the second cable C2 is pulled, as shown in FIGS. 3 and 4.

Here, as shown in FIG. 1, the operating lever 540 is operated in a state in which the seatback 12 is located upright. Further, as shown in FIG. 2, the operating lever 540 is provided to rotate the seatback 12 in the folding direction. In this case, the operation of the operating lever 540 may be a first operation to sequentially operate the first driving guide 510 to the third driving guide 530 in order to switch the operation mode from the electric mode to the manual mode.

In other words, when the operating lever 540 is rotated through pushing operation thereof, as shown in FIGS. 5 and 6, the second cable C2 is pulled. Further, when the second cable C2 is pulled in this way, the first driving guide 510 is rotated counterclockwise (refer to FIGS. 3 and 4). In this manner, when the first driving guide 510 is rotated, the locking member 512 rotates the protruding piece 522 (refer to FIGS. 7 and 8), and the first cable C1 is moved in a direction in which the first cable C1 is pulled by rotation of the second driving guide 520.

As a result, when the first cable C1 is pulled, the first bracket 532 and the second bracket 534 are sequentially rotated to move the connecting member 420 upwards. Accordingly, the main body 410 is rotated from the first position to the second position such that the pinion gear 402 is selectively disengaged from the rack gear 102. In this manner, the upper rail 200 mounted on the seat cushion 10 may be moved in the forward-and-rearward direction of the lower rail 100 according to the selectively switched manual mode.

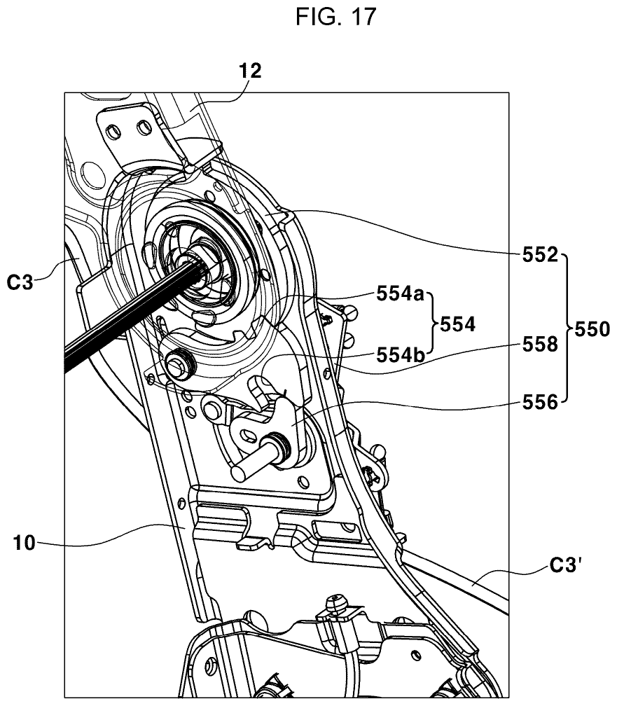

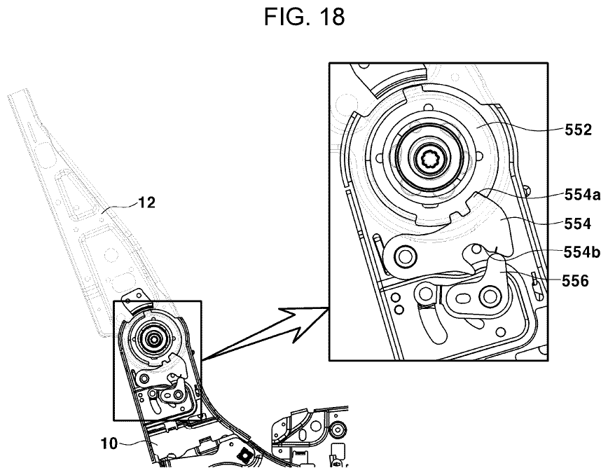

Meanwhile, as shown in FIGS. 17 and 18, the guide module 500 includes a switching guide 550 connected to the seatback 12 and configured to transmit driving force to switch the position of the seatback 12 from the first position corresponding to the electric mode to the second position corresponding to the manual mode.

That is, the switching guide 550 is configured to allow the seatback 12 having an electric recliner function to selectively switch from the automatic mode to the manual mode, for example, when the second-row seat needs to be moved forwards to allow a passenger sitting on the third-row seat to enter or exit the vehicle. In this case, the passenger sitting on the third-row seat may quickly enter or exit the vehicle through angle adjustment of the seatback 12 according to the manual mode of the seatback 12.

To this end, the switching guide 550 may include a support member 552, a first rotation member 554, a second rotation member 556, and a third rotation member 558.

As shown in FIG. 20, the support member 552 is rotatably coupled to the seatback 12 with an elastic mechanism.

More specifically, the support member 552 may be rotatably coupled to the seatback 12 by a restoring spring (not shown). Accordingly, when the support member 552 is selectively disconnected from the first rotation member 554, the seatback 12 may be rotated in the folding direction thereof by elastic restoring force acting on the restoring spring (not shown).

In addition, the first rotation member 554 includes a protruding locking piece 554a configured to be inserted into the support member 552 and a locking groove 554b formed at a location opposite or spaced apart from the locking piece 554a, and is formed to be axially rotatable (refer to FIG. 18).

The first rotation member 554 may be located to be locked with the support member 552 by the locking piece 554a at the first position corresponding to the electric mode and may be located to be unlocked from the support member 552 at the second position corresponding to the manual mode.

In addition, the second rotation member 556 is located to be caught by the first rotation member 554 and is selectively inserted into the locking groove 554b by rotation thereof. Accordingly, the first rotation member 554 is guided by the second rotation member 556 and is rotated to perform switching from the first position to the second position. In this manner, the first rotation member 554 is unlocked from the support member 552.

In other words, the second rotation member 556 is formed to have a shape corresponding to the locking groove 554b and is located to be locked at the entrance of the locking groove 554b. Here, when the second rotation member 556 is rotated in conjunction with rotation of the third rotation member 558, the second rotation member 556 is inserted into the locking groove 554b so as to guide the first rotation member 554 in a direction in which the first rotation member 554 is moved downwards and is axially rotated by elasticity. Thereafter, the first rotation member 554 is unlocked from the support member 552.

As shown in FIG. 17, the third rotation member 558 is coupled to the second rotation member 556 at a location where the third rotation member 558 and the second rotation member 556 face each other through the same rotation axis, and is connected to an operating cable C3 so as to be connected to the operating lever 540 through the operating cable C3.

Here, the operating lever 540 is mounted on at least one of the seat cushion 10 and the seatback 12. Preferably, as shown in FIG. 15, the operating lever 540 may be mounted on the seatback 12 and may be connected to the third rotation member 558 through the operating cable C3. Alternatively, as shown in FIG. 16, the operating lever 540 may be mounted on the seat cushion 10 and may be connected to the third rotation member 558 by an operating cable C3′.

Descriptions will be sequentially given as to how the seatback 12 switches from the electric mode to the manual mode based on the configuration of the aforementioned switching guide 550.

For example, when a passenger sitting on the third-row seat enters or exits the vehicle, an actuator 1 is operated to move the second-row seat forwards. In this case, a locking guide 559 connected to the actuator 1 is also operated to rotate the locking module 600, and a slide motor (not shown) is driven to enable the upper rail 200 to be slidably moved according to the electric mode.

At this time, when the upper rail 200 is moved, the seatback 12 is also rotated in a direction in which the seatback 12 is folded according to the electric mode. Here, when the seatback 12 needs to switch from the electric mode to the manual mode in order to allow the passenger sitting on the third-row seat to quickly enter or exit the vehicle, as shown in FIGS. 15 and 16, the operation of the switching guide 550 by the operating cable C3 or C3′ may be selectively performed by operating the operating lever 540 in the pulling direction.

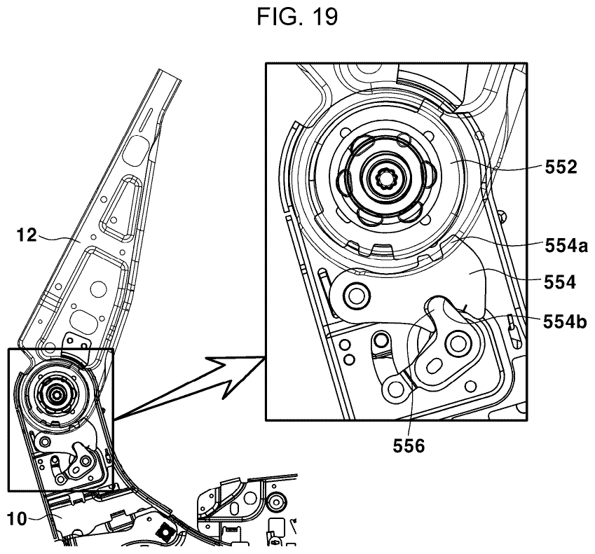

When the switching guide 550 is operated, as shown in FIG. 18, the second rotation member 556 rotated in conjunction with rotation of the third rotation member 558 is located to be caught by the first rotation member 554. In this state, as described above, when the third rotation member 558 is rotated by operating the operating lever 540 in the pulling direction, the second rotation member 556 is inserted into the locking groove 554b and is locked therein, as shown in FIG. 19.

Accordingly, the first rotation member 554 is axially rotated in a direction away from the support member 552, and the locking piece 554a is sequentially unlocked from the support member 552. In this case, the support member 552 is freely rotated to a set location by elastic restoring force acting on the restoring spring (not shown) of the support member 552, so that the seatback 12 may be quickly rotated in the folding direction thereof.

As a result, in the present embodiment, the seatback 12 driven according to the electric mode may be driven according to the manual mode through the selective operation of the switching guide 550, and the seatback 12 may easily switch from the electric mode to the manual mode. In this manner, since the passenger sitting on the third-row seat may quickly enter or exit the vehicle, user satisfaction may be improved.

In this manner, after the seatback 12 switches from the electric mode to the manual mode, when the seatback 12 is rotated in the folding direction by elastic restoring force acting on the restoring spring (not shown) of the support member 552, the guide module 500 is operated to transmit driving force to move the second gear module 400 downwards from the first position corresponding to the electric mode to the second position corresponding to the manual mode. More specifically, as described above, the first driving guide 510 is rotated counterclockwise (refer to FIGS. 3 and 4). Accordingly, the locking member 512 rotates the protruding piece 522 (refer to FIGS. 7 and 8) through rotation of the first driving guide 510, and then the first cable C1 is moved in the pulling direction thereof through rotation of the second driving guide 520.

As a result, when the first cable C1 is pulled, the first bracket 532 and the second bracket 534 are rotated to move the connecting member 420 upwards.

Accordingly, the main body 410 is rotatably moved from the first position to the second position, and then the pinion gear 402 is selectively disengaged from the rack gear 102 so as to enable the seat cushion 10 to selectively switch from the electric mode to the manual mode along with the seatback 12. Consequently, according to the manual mode, the upper rail 200 may be moved in the forward-and-rearward direction of the lower rail 100.

According to the present disclosure, in order to switch an operation mode from an electric mode to a manual mode, a seatback is first rotated in the folding direction through operation of a lever, a cable is accordingly pulled by rotation of the seatback such that a rotating housing cover connected to the cable is rotated relative to a fixed housing cover, and a pinion gear is selectively disengaged from a rack gear, thereby having an effect of enabling a seat having a mechanical connection structure to easily switch from the electric mode to the manual mode.

In addition, the present disclosure enables the operation of the seat according to the electric mode or the manual mode by the mechanical connection structure, thereby having an effect of reducing costs and achieving stable operation compared to a seat having an electronic connection structure.

Furthermore, since the present disclosure enables the seatback to selectively switch to the electric mode or the manual mode along with a seat cushion, a passenger sitting on the rear seat may quickly enter or exit the vehicle, thereby having an effect of improving user satisfaction.

As is apparent from the above description, the present disclosure provides a long slide rail system for a vehicle seat, configured to switch an operation mode from an electric mode to a manual mode in such a manner that a seatback is first rotated in the folding direction through operation of a lever, a cable is accordingly pulled by rotation of the seatback such that a rotating housing cover connected to the cable is rotated relative to a fixed housing cover, and a pinion gear is selectively disengaged from a rack gear. Through such a structural configuration, the long slide rail system enables a seat having a mechanical connection structure to easily switch from the electric mode to the manual mode.

In addition, the long slide rail system enables the operation of the seat according to the electric mode or the manual mode by the mechanical connection structure, thereby having an effect of reducing costs and achieving stable operation compared to a seat having an electronic connection structure.

Furthermore, since the long slide rail system enables the seatback to selectively switch to the electric mode or the manual mode along with a seat cushion, a passenger sitting on the rear seat may quickly enter or exit the vehicle, thereby having an effect of improving user satisfaction.

The present disclosure has been described in detail with reference to preferred embodiments shown in the drawings, but the embodiments are merely illustrative. It will be appreciated by those skilled in the art that various modifications may be made to the embodiments, and all or a part of the embodiments may be selectively combined with each other. Therefore, the true technical protection scope of the present disclosure should be defined by the technical spirit of the appended claims.

What is claimed is:

1. A long slide rail system for a vehicle seat, the long slide rail system comprising:
a lower rail configured to extend lengthwise along a floor panel of a vehicle, the lower rail configured to be fixedly installed on the floor panel;
an upper rail coupled to the lower rail and configured to be mounted on a seat cushion, the upper rail configured to enable the seat cushion to be slidably movable along the lower rail;
a first gear module fixedly mounted on the upper rail, the first gear module configured to be operably connected to a drive motor;
a second gear module configured to be coupled in an axially rotatable manner to the first gear module, the second gear module including a pinion gear configured to be engaged with a rack gear provided on the lower rail; and
a guide module configured to selectively rotate the second gear module to disengage the pinion gear from the rack gear such that the second gear module is guided and moved by the guide module from a first position corresponding to an electric mode to a second position corresponding to a manual mode.

2. The long slide rail system of claim 1, wherein the second gear module includes:
a main body formed so that the pinion gear is to be mounted on an outer side thereof, the main body housing a plurality of gears on an inner side thereof, each of the gears being configured to transmit driving force of the first gear module to the pinion gear; and
a connecting member coupled to the main body, the connecting member configured to vertically extend from the main body so as to be connected to the guide module.

3. The long slide rail system of claim 2, wherein an upper part of the main body is arranged to extend obliquely so as to be coupled to a rear side of the first gear module.

4. The long slide rail system of claim 2, wherein the second gear module further includes an elastic member connected to the first gear module, wherein the elastic member is configured to:
provide elastic force to the second gear module at an initial position, and
provide elastic restoring force clockwise to the second gear module upon the connecting member being moved upwards such that the main body is rotated relative to the first gear module counterclockwise from the initial position.

5. The long slide rail system of claim 2, wherein the guide module includes:
a first driving guide configured to be rotated in conjunction with rotation of a seatback rotatably coupled to the seat cushion;
a second driving guide selectively located to be caught by the first driving guide through rotation of the first driving guide, the second driving guide configured to be rotated in a direction opposite to a rotation direction of the first driving guide; and
a third driving guide configured to selectively move the connecting member upwards upon being rotated by a first cable, the first cable being movable in a direction in which the first cable is pulled by rotation of the second driving guide.

6. The long slide rail system of claim 5, wherein the third driving guide includes:
a first bracket connected to the first cable, the first bracket configured to be selectively rotated upon being moved in the direction in which the first cable is pulled; and
a second bracket formed to extend from the first bracket, the second bracket configured to be rotated in conjunction with rotation of the first bracket to selectively move a locking module to an unlocked position.

7. The long slide rail system of claim 6, wherein the locking module is mounted on the upper rail and is configured to be selectively unlocked from a locking hole provided in the lower rail upon being pressed by the second bracket.

8. The long slide rail system of claim 5, wherein the guide module further includes an operating lever connected to the first driving guide through a second cable, the operating lever configured to rotate the seatback by moving the second cable in a direction in which the second cable is pulled.

9. The long slide rail system of claim 1, wherein the guide module includes a switching guide connected to a seatback rotatably coupled to the seat cushion, the switching guide configured to transmit driving force to switch the seatback from the first position corresponding to the electric mode to the second position corresponding to the manual mode.

10. The long slide rail system of claim 9, wherein the switching guide includes:
a support member rotatably coupled to the seatback;
a first rotation member configured to be rotatable, the first rotation member including a locking piece configured to be inserted into the support member and a locking groove formed at a location opposite from the locking piece;
a second rotation member positioned so as to be caught by the first rotation member during rotation, the second rotation member configured to be selectively inserted into the locking groove to guide and rotate the first rotation member such that the first rotation member is unlocked from the support member; and
a third rotation member coupled to the second rotation member and configured to be rotated in conjunction with rotation of the second rotation member, the third rotation member connected to an operating lever by an operating cable.

11. The long slide rail system of claim 10, wherein the operating lever is mounted on at least one of the seat cushion and the seatback and is configured to rotate the third rotation member by moving the operating cable in a direction in which the operating cable is pulled.

12. The long slide rail system of claim 10, wherein:
the first position is set to allow the first rotation member to be locked in the support member, and
the second position is set to allow the first rotation member to be unlocked from the support member.

13. The long slide rail system of claim 9, wherein:
the guide module further includes a locking module mounted on the upper rail, the locking module configured to be inserted into a locking hole provided in the lower rail to restrict sliding movement of the upper rail, and
the locking module is configured to be unlocked from the locking hole by driving an actuator.

14. The long slide rail system of claim 13, wherein:
the locking module is configured to be rotated by operation of a locking guide connected to the actuator, and
the locking module is configured to be unlocked from the locking hole to enable, by driving a slide motor, the sliding movement of the upper rail.

15. The long slide rail system of claim 10, wherein the switching guide is selectively operated by operation of the operating lever.
